(19) United States
(12) Patent Application Publication
(10) Pub. No.: US 2025/0341340 A1
(43) Pub. Date: Nov. 6, 2025

(54) DEVICE FOR TRANSFERRING AN ACTIVE SUBSTANCE TO A GAS PHASE

(71) Applicant: Innovative Sensor Technology IST AG, Ebnat-Kappel (CH)

(72) Inventors: Marco Schossig, Dresden (DE); Tobias Ott, Dresden (DE); Stefan Wolf, Wil (CH); Florian Krogmann, Kreuzlingen (CH)

(21) Appl. No.: 18/862,347

(22) PCT Filed: Apr. 28, 2023
(86) PCT No.: PCT/EP2023/061383

§ 371 Date: Nov. 1, 2024

(30) Foreign Application Priority Data
May 2, 2022 (DE) 10 2022 110 722.1

(51) Int. Cl. F24H 1/20; A24F 40/10; A24F 40/44; A24F 40/46; B32B 1/00; B32B 3/26; B32B 5/02; B32B 15/14; H05B 3/00; H05B 3/26

(52) U.S. Cl. CPC F24H 1/202; A24F 40/10; A24F 40/44; A24F 40/46; B32B 1/00; B32B 3/266; B32B 5/022; B32B 15/14; H05B 3/0052; H05B 3/26; B32B 2250/42; H05B 2203/007; H05B 2203/013

(57) ABSTRACT

A device for transferring an active substance to a gas phase, which active substance contains at least one organic component, includes: a reservoir, which is designed to receive the active substance; and a heating element, which is made from a film of a nickel-chromium alloy or a refractory metal, wherein the heating element is designed to emit thermal radiation, and wherein the heating element is arranged with respect to the reservoir such that the active substance is heated at least by the thermal radiation emitted from the heating element.

The invention relates to a device for transferring an active substance to a gas phase, which active substance contains at least one organic component.

A plurality of hand-held, steam-generating devices for consumption are known from the prior art. What all these devices have in common is that they are designed to accommodate a consumable product that contains a solid or liquid medium. The solid or liquid medium contains active substance and is heated by a heating element of the device so that the active substance is transferred to a gas phase and thus assumes a gaseous state or an aerosol form. This gas phase is subsequently inhaled by a consumer or user.

An example of such devices are electronic cigarettes or evaporators. Their consumption products contain a liquid containing the active substance, which liquid is evaporated. The active substance can be, for example, nicotine, a medicinal active substance or it can be designed to be drug-free and nicotine-free, for example, in the case of tea. In the case of nicotine as the active substance, the liquid usually consists of a mixture of glycerin, 1,2-propanediol, flavors and nicotine.

Another example of such devices are so-called tobacco heaters, in particular heat-not-burn products. Heat-not-burn (HnB) tobacco products are an alternative to conventional cigarettes. They use heating elements attached in a heating chamber to heat the tobacco containing nicotine as an active substance instead of burning it. The result of heating is a nicotine-containing aerosol as a gas phase, which is inhaled by the user. HnB products differ from other types of steam generators in that genuine tobacco is heated instead of a liquid containing nicotine. For this purpose, the consumption product is designed as a tobacco stick, which is inserted into a heating chamber of the HnB product, is typically pierced by the heating element, and is subsequently heated by the heating element or walls of the heating chamber.

All HnB products commercially available (for example, “IQOS” from PMI, “LilPlus” from KT&G; “Glo” from BAT, “IUOC 2” from SYT, “Monk” from CT, etc.) and further types of steam generators use electronically controlled heating elements based on resistive (Joule) heating.

Currently, most of these devices use wound Kanthal resistors to heat and evaporate the active substance. The disadvantage of this approach is the relatively high energy consumption of a wound wire, which—also due to its high thermal mass—must be heated continuously in order to provide enough steam for the consumer at all times.

These disadvantages can be avoided by using thin Kanthal meshes, which also allows for a more energy-efficient pulsed heating cycle due to their low thermal mass.

However, the low mass is accompanied by very low mechanical stability, which means that the long-term stability of such devices is not ensured.

The invention is based on the object of providing a device which allows an energy-efficient conversion of an active substance into a gas phase with high long-term stability.

The object is achieved by a device for transferring an active substance to a gas phase, which active substance contains at least one organic component, said device comprising:
a reservoir, which is designed to receive the active substance;
a heating element, which is made from a film of a nickel-chromium alloy or a refractory metal, wherein the heating element is designed to emit thermal radiation, and wherein the heating element is arranged with respect to the reservoir such that the active substance is heated at least by means of the thermal radiation emitted from the heating element.

According to the invention, a film is used as a heating element. The film is designed to be thin and has a thickness in a range of approximately 0.5 μm to 25 μm. It has been shown that such a film, in particular if it consists of a nickel-chromium (NiCr) alloy, emits thermal radiation in the infrared wavelength range when exposed to an electric current or an electric voltage. The heating of the active substance is therefore very efficient, since the heat is transferred not only via thermal conduction (when the active substance comes into contact with the heating element), but also via thermal radiation. In the same period of time, the heating element of the device according to the invention can thus introduce more heat into the active substance than heating elements used in devices known from the prior art.

It has also been shown that thermal radiation in the infrared wavelength range interacts particularly well with the organic components of the active substance, making heating even more efficient. For example, such a heating element emits a particularly high amount of thermal radiation in the wavelength range in which glycerin, which is a component of many liquids for e-cigarettes, mainly absorbs (in the range around 3 μm wavelength).

Such a heating element combines a low thermal mass (resulting in fast heating rates of up to 2000 Kelvin per second) with good mechanical stability, which increases the long-term stability compared to prior art devices.

The terms “active substance” and “reservoir” should be understood broadly in the context of the device according to the invention. Active substances include medicinal substances such as herbs or medicines, plant-based substances, nicotine, etc., but also drug-free and nicotine-free substances such as flavorings, etc. The active substances can be dissolved in a liquid which is added to the reservoir. However, a reservoir can also be the natural source of an active substance that is added to the device, e.g., tobacco in the case of the active substance nicotine (see e.g., tobacco sticks in HnB products).

In addition to the aforementioned components “heating element” and “reservoir,” such a device can comprise one or more of the following components: a mouthpiece for receiving the gas phase by a user, an electrical energy supply unit, e.g., a battery or a rechargeable battery, control electronics or a control/evaluation unit for controlling the heating element, at least one operating element for starting the heating process by an operator, and a housing in which the aforementioned components are arranged.

In accordance with a first variant of the device according to the invention, it is provided that the heating element is arranged with respect to the reservoir such that a contactless heat transfer by means of the emitted thermal radiation from the heating element to the active substance is established. The heating element itself is therefore not in heat-conducting contact with the reservoir or the active substance, so that heat transfer occurs substantially via the thermal radiation emitted by the heating element.

An advantageous embodiment of the first variant of the device according to the invention provides that the heating element is introduced into a housing, wherein the housing has a window, which window is designed to be permeable to the thermal radiation, and wherein the window is attached to the reservoir such that the window is in contact with the active substance. The housing is, for example, an encapsulated housing such as that used for IR radiators. Depending on the design, the reservoir is arranged with respect to the window such that the reservoir and/or the active substance is in contact with the window. The heating element does not contact the window. The window consists of, for example, sapphire, silicon, germanium, calcium fluoride, barium fluoride, zinc selenide, diamond, or glass.

An advantageous alternative embodiment of the first variant of the device according to the invention provides that the heating element is arranged remotely from the reservoir and wherein the heating element is directed towards the reservoir such that the thermal radiation emitted by the heating element mainly strikes the active substance. In this embodiment, the heating element can also be installed in a housing with a window as described above.

In accordance with a second variant of the device according to the invention, it is provided that the heating element is arranged with respect to the reservoir such that the heating element contacts the active ingredient and that heat transfer from the heating element to the active substance is established by means of thermal radiation and thermal conduction.

An advantageous embodiment of the second variant of the device according to the invention provides that the heating element is shaped such that it has a recess for receiving a medium containing the active substance. The medium is, for example, a liquid in which the active substance is dissolved. Components of the reservoir itself, e.g., parts of the tobacco leaves in the case of using a tobacco stick as a reservoir, can also be considered as a medium.

For this purpose, the heating element has a depression or recess into which the medium is introduced. In the case of a liquid as the medium, it can be provided that the liquid is continuously replenished from the reservoir, or that the depression or recess is filled only once per use.

An advantageous alternative embodiment of the second variant of the device according to the invention provides that the heating element is arranged within the reservoir such that the heating element is immersed in the reservoir in the filled state of the reservoir and in particular is substantially completely covered with a medium containing the active substance. The medium is, for example, a liquid in which the active substance is dissolved. Parts of the tobacco leaves can also be considered as a medium, for example, in the case of using a tobacco stick as a reservoir.

An advantageous alternative embodiment of the second variant of the device according to the invention provides that the active substance is contained in a liquid, wherein the heating element consists of a layer composite with an n-fold number of layers of the film and an n+1-fold number of nonwoven layers, wherein n>=1, wherein the layer composite is constructed such that the layers of the film alternate with the nonwoven layers and wherein the bottom layer and the top layer of the layer composite are formed by nonwoven layers, and wherein the nonwoven layers are designed to absorb the liquid. The heating element is therefore constructed layer by layer from layers of metal film and nonwoven layers. This allows the active substance to be heated even more efficiently.

Alternatively, it is intended that the layers of the film form the top and bottom layers of the layer composite.

In the simplest case, the heating element consists of a layer of film, which is covered on both sides by a nonwoven layer. To increase the heating efficiency and the quantity of liquid that can be heated, the number of layers of the film—and thus the number of nonwoven layers—can be increased. A film layer is therefore always covered on both sides by a nonwoven layer to prevent the film layers from burning through.

Advantageously, the layers of the film are electrically connected in parallel or in series. In the case of parallel connection, the layers of the film have a low electrical resistance, which makes this variant suitable for electrical control with high electrical currents. In the case of a serial connection, the layers of the film have a high electrical resistance, which makes this variant suitable for electrical control with low electrical currents.

An advantageous alternative embodiment of the second variant of the device according to the invention provides that the active substance is contained in a liquid, wherein the heating element consists of a layer composite with a layer of the film and a nonwoven layer, wherein the layer composite is rolled up in a cylindrical shape, and wherein the nonwoven layer is designed to absorb the liquid. In contrast to the layer composite described above, the heating element consists of a single, long layer of film, which is covered with a nonwoven layer. This covered layer of film is rolled up such that the nonwoven layer is on the outside, so that when viewed from the outside of the cylinder only the nonwoven layer is visible, but not the layer of film, in order to prevent any possible burning through of the film layer. This design is characterized by a high electrical resistance, which makes the heating element suitable for electrical control with low electrical currents

An advantageous embodiment provides that the nonwoven layer or layers contact the liquid, and wherein the nonwoven layer is designed to form a capillary effect for moving the liquid towards the layer of the film or layers of the film. This means that new liquid is automatically supplied to the nonwoven layers or the nonwoven layer.

Advantageously, in one embodiment, the device comprises a control/evaluation unit, wherein the control/evaluation unit is designed to determine a quantity of liquid in the nonwoven layer or nonwoven layers via a capacitance measurement, wherein the layer of the film or the layers of the film act as electrodes. For this purpose, at least two layers of film are required if the layer composite is used, or one layer of film if the rolled variant is used. In the former case, the layer composite acts similarly to a plate capacitor, in the latter case like a wound capacitor. Ideally, the layers of the film form the top and bottom layers of the layer composite.

In an advantageous embodiment, the layer composite is produced by connecting the at least one layer of the film and the at least one nonwoven layer by means of thermal joining or lamination.

Advantageously, at least one nonwoven layer is perforated. Additionally or alternatively, it can be provided that at least one layer of the film is perforated. By converting the liquid into the gas phase, evaporation material is generated, which, due to the lower density, could lead to swelling of the nonwoven layers and an associated high mechanical stress on the layers of the films. To prevent possible irreparable damage to the heating element, perforations can be provided in the nonwoven layers and/or in the layer(s) of the film.

In the simplest case, the perforation of the nonwoven layers is formed by using a porous nonwoven as the material. Alternatively or additionally, a directed perforation is provided, in particular orthogonal to the stacking direction, in order to improve the discharge of the gas phase.

The perforation of the layer(s) of the film can also be undirected. However, by carefully designing the perforation, the electrical resistance of the layers of the film can be adjusted: If perforation is orthogonal to the direction of current, the electrical resistance of the layer(s) increases—in the direction of current, however, there is no effect on the electrical resistance except for the reduction of the cross-sectional area of the film. By means of an advantageous embodiment of the perforation, the electrical properties of the film layer (electrical resistance, etc.) can be adapted to the electrical current provided by the energy source, so that the desired heating output is achieved.

An advantageous embodiment of the device according to the invention provides that the film consists of a first layer and a second layer applied to a first side of the film, wherein the second layer has a nanostructuring.

An advantageous embodiment of the device according to the invention provides that the film consists of a first layer, a second layer applied to a first side of the film and a third layer applied to a second side of the film, wherein the second layer and the third layer have a nanostructuring.

In both cases, the nanostructures, which also consist of the metallic material, in particular the NiCr alloy, ensure an increase in the thermal radiation emission due to an adjustment of the refractive index between the metal film and the surrounding medium. In the simplest case, the nanostructuring is disordered and creates a porous surface.

Nanostructuring can be advantageously used for all of the aforementioned embodiments of the heating element.

Advantageously, the nanostructuring is designed such that it is hydrophobic towards the transferred gas phase and that the nanostructuring forms channels for the discharge of the transferred gas phase. This can improve the discharge of the formed gas phase and increase the efficiency of the heating element. For this purpose, the nanostructures are designed, for example, as nanocones or nanorods with a very small height of less than or equal to 100 nm.

Alternatively, the nanostructuring is designed such that it is hydrophilic towards the transferred gas phase. For this purpose, the nanostructures are designed, for example, as nanorods with a size of more than 100 nm.

The invention is explained in greater detail with reference to the following figures. In the figures:

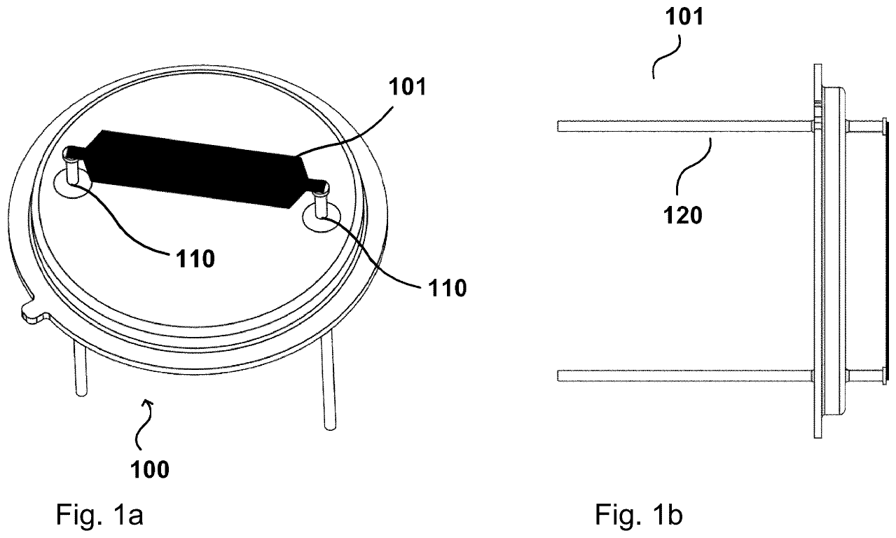

FIG. 1 shows an embodiment of a heating element of the device according to the invention;

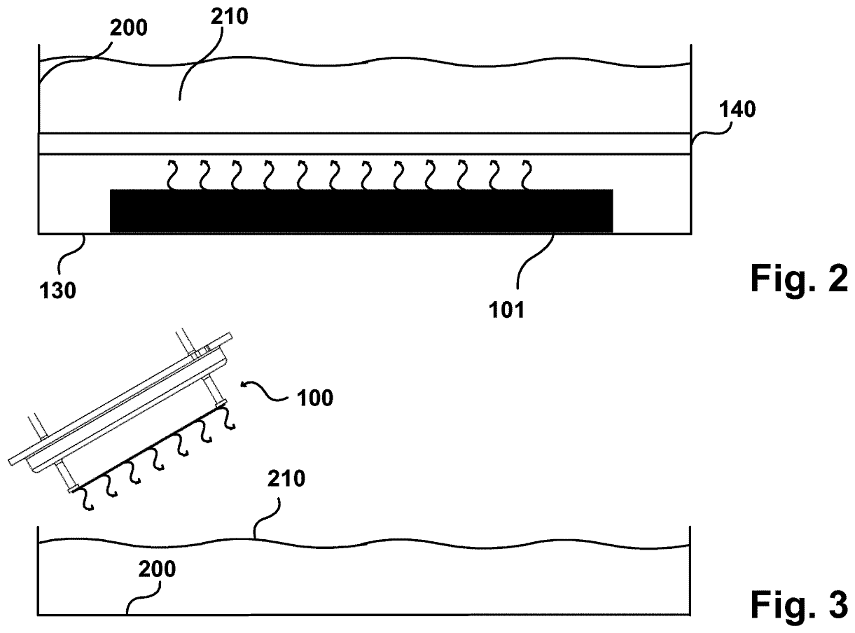

FIG. 2 shows a first embodiment of the device according to the invention;

FIG. 3a shows a second embodiment of a device according to the invention.

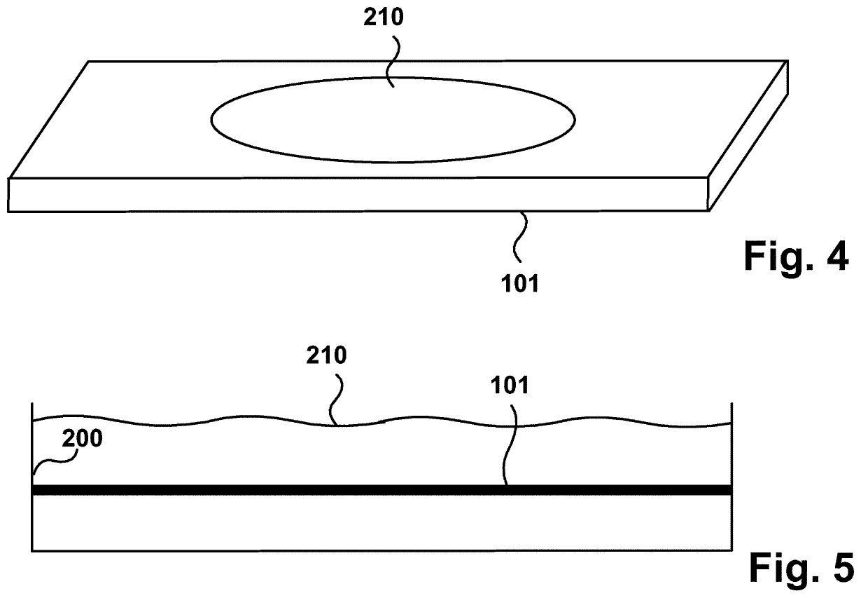

FIG. 4 shows a third embodiment of the device according to the invention.

FIG. 5 shows a second embodiment of a device according to the invention.

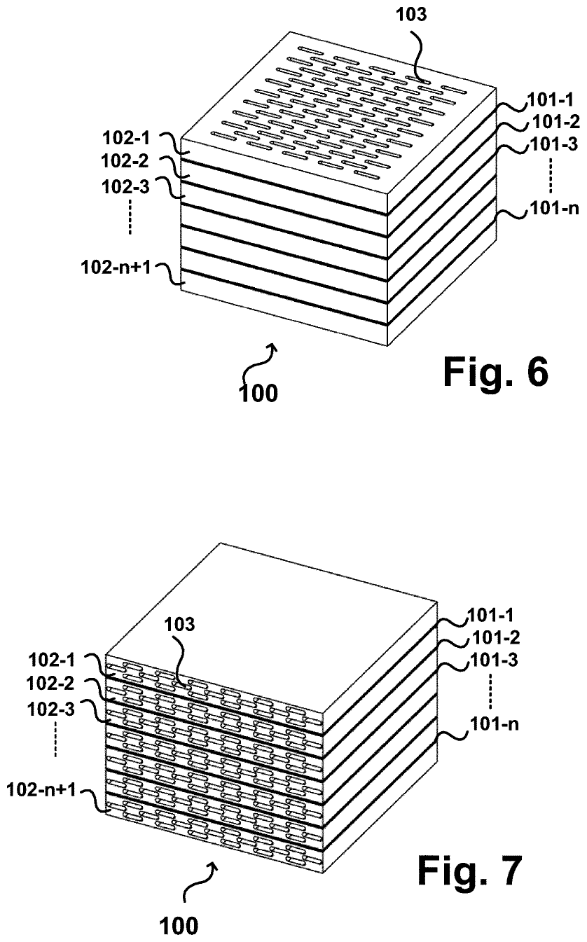

FIG. 6 shows an embodiment of the heating element as a layer stack;

FIG. 7 shows another embodiment of the heating element as a layer stack;

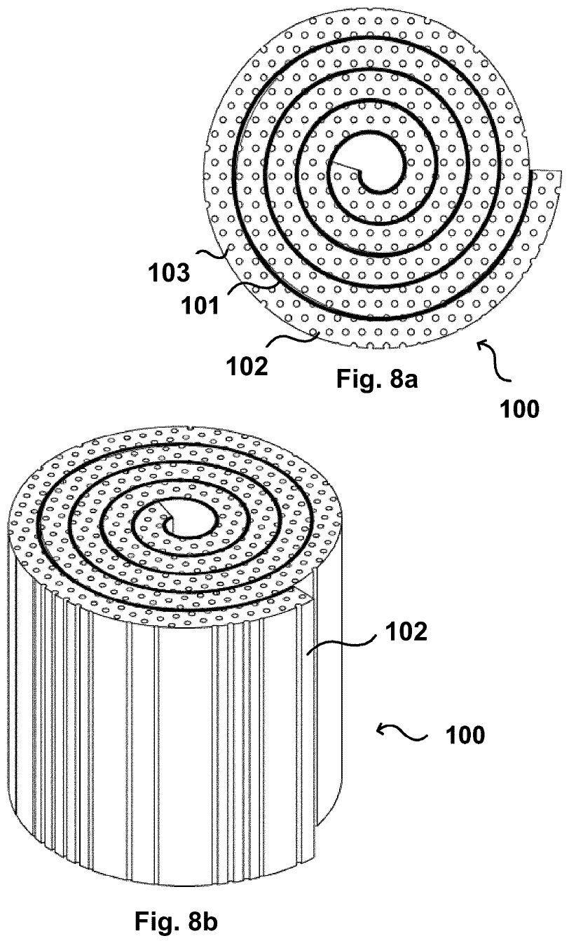

FIG. 8 shows an embodiment of a rolled-up heating element; and

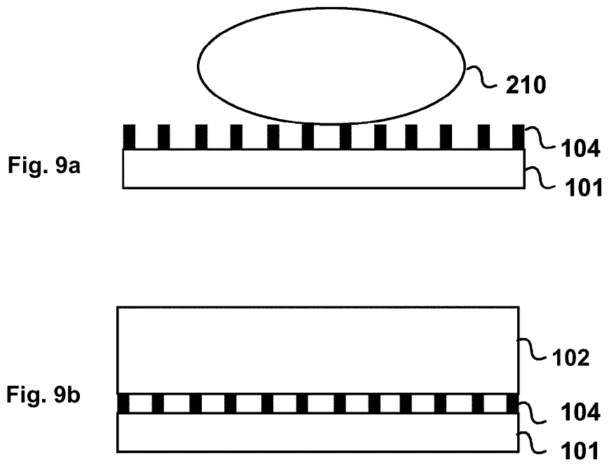

FIG. 9 shows embodiments for nanostructuring of the heating element film.

FIG. 1 shows an embodiment of the heating element 100 of the device according to the invention. The structure of this heating element is the basis for the embodiments of the device shown in FIG. 2 to FIG. 5. The left drawing (FIG. 1a)) shows a top view of the heating element 100, the right drawing (FIG. 1b)) shows a side view of the heating element 100.

The heating element 100 includes a layer of a thin film 101 made of a NiCr alloy. The thickness of the film is in an approximate range of 0.5 μm to 25 μm. The film 101 is cut into the shape of a narrow strip and attached in a floating manner between two contact pins 110. The fastening can be established, for example, by means of resistance welding. The contact pins 110 themselves are attached to a housing base 120. The formation of the film 101 as a strip and the mechanical contacting at the contact pins 110 results in a high mechanical stability of the heating element 100.

In addition to mechanically fastening the film 101, the contact pins 110 serve to electrically contact the film 101 with a voltage or current source, which serves to apply electrical power to the film. Applying the electrical voltage to the film 101 results in heating of the film 101, whereby said film emits thermal radiation in the infrared spectrum.

In the following, several possibilities are shown how such a heating element 100 can be arranged in a device according to the invention with respect to a reservoir 200 with an active substance 210. In all embodiments described below, the active substance 210 is dissolved in a liquid.

FIG. 2 shows a variant of the device in which there is no contact or touch between the reservoir 200 and the heating element 100. For this purpose, the housing 130 of the heating element 100 is closed by placing a cap on the housing base 120 and welding it to the housing base 120. The housing 130 contains a window 140 which is made of a material which is permeable to thermal radiation, in particular sapphire, silicon, germanium, calcium fluoride, barium fluoride, zinc selenide, diamond or glass. The moiety of the housing 130 is not, or significantly less, permeable to thermal radiation.

The reservoir 200 is arranged with respect to the housing 130 such that the bottom of the reservoir 200 contacts the window 140, or that the liquid containing the active substance 210 contacts the window 140. The thermal radiation (see arrows) of the film 101 heated by the applied electrical power strikes the reservoir 200 or the liquid, whereby the liquid with the active substance is transferred to the gas phase by evaporation. The active substance 210 comprises an organic component which absorbs thermal radiation particularly well and accelerates the transfer.

FIG. 3 shows a further variant of the device in which there is no contact or touch between the reservoir 200 and the heating element 100. Here, the heating element 100 is arranged remotely from the reservoir 200, but positioned with respect to the reservoir 200 such that the thermal radiation emitted by the heating element 100 is largely directed at the liquid containing the active substance 210 in the reservoir, causing it to change into the gas phase.

FIG. 4 shows a variant of the device in which there is a heat-conducting contact or touch between the liquid and the heating element 100. The film 101 has a recess or hollow for this purpose or can be shaped like a boat. The liquid is poured directly into the hollow.

In addition to the resulting thermal radiation, the film 101 additionally heats the liquid by thermal conduction, whereby the liquid with the active substance 210 contained therein quickly passes into the gas phase.

FIG. 5 shows a variant of the device in which there is a heat-conducting contact or touch between the reservoir 200 and the heating element 100. The reservoir is attached directly to the heating element 100 so that the film 101 is completely in the liquid when the reservoir 200 is filled. For this purpose, for example, the housing base 130 is provided with walls so that the reservoir is formed. Just as in the previous embodiment, the liquid is heated not only by the resulting thermal radiation but also by thermal conduction from the film 101 contacting the liquid, whereby the liquid with the active substance 210 contained therein quickly passes into the gas phase.

FIG. 6 shows an embodiment of a heating element 100, which is constructed fundamentally differently than the heating elements described in FIGS. 1 to 5. The heating element 100 consists of a layer composite which is constructed layer by layer from layers of the film 101-1, 101-2, . . . , 101-n and nonwoven layers 102-1, 102-2, . . . , 102-n+1. The layers of the film 101-1, 101-2, . . . , 101-n and nonwoven layers 102-1, 102-2, . . . , 102-n+1 are connected to one another, for example by lamination. In such a structure, the individual layers of the film 101-1, 101-2, . . . , 101-n can be connected in parallel or in series and electrically contacted, depending on which electrical parameters are specified by the control/evaluation unit.

The liquid with the active substance 210 is located in the nonwoven layers 102-1, 102-2, . . . , 102-n+1. Each layer of the film 101-1, 101-2, . . . , 101-n is in contact with two nonwoven layers 102-1, 102-2, . . . , 102-n+1. Thus, a high thermal transfer from the layers of the film 101-1, 101-2, . . . , 101-n into the active substance 210 is possible due to the large contact area. By applying electrical energy to the layers of the film 101-1, 101-2, . . . , 101-n, they heat up and release heat in the form of thermal radiation and thermal conduction to the individual nonwoven layers 102-1, 102-2, . . . , 102-n+1 containing the liquid with the active substance, so that the active substance passes into the steam phase. The nonwoven layers 102-1, 102-2, . . . , 102-n+1 are each immersed at one of their ends in the reservoir 200, so that new liquid is constantly fed into the nonwoven layers 102-1, 102-2, . . . , 102-n+1 by the capillary effect.

From a purely electrical perspective, the structure of the layer composite is a plate capacitor, wherein the layers of the film 101-1, 101-2, . . . , 101-n depict the electrodes. This has the advantage that the control/evaluation unit can determine via a capacitance measurement how much of the liquid is still in the individual nonwoven layers 102-1, 102-2, . . . , 102-n+1.

By converting the liquid into the steam phase, the volume increases significantly, since gases have a much lower density than liquids. If this resulting gas volume is not removed, the nonwoven layers 102-1, 102-2, . . . , 102-n+1 could swell and thus cause mechanical damage to the layers of the film 101-1, 101-2, . . . , 101-n, which could lead to irreparable damage to the heating element 100. To prevent this, perforations 103 are introduced into the nonwoven layers 102-1, 102-2, . . . , 102-n+1. In the simplest case, these can be inherently contained in the nonwoven layers 102-1, 102-2, . . . , 102-n+1 by choosing a porous nonwoven material. Alternatively, these perforations 103 are mechanically introduced into the nonwoven layers 102-1, 102-2, . . . , 102-n+1, in the case of FIG. 6 in the stacking direction. In this example, the layers of the film 101-1, 101-18, . . . , 101-n also have corresponding perforations 103 so that gases resulting in the middle nonwoven layers can also be discharged.

FIG. 7 shows a similar heating element 100 as already described in FIG. 6. However, the perforations 103 are introduced in this case orthogonal to the stacking direction so that the resulting gases can escape from each stacking level. Here, the layers of the film 101-1, 101-2, . . . , 101-n do not necessarily have to be provided with perforations 103.

FIG. 8 shows another embodiment of a heating element 100 which uses such a nonwoven layer 102. The upper drawing (FIG. 8a)) shows a top view of the heating element 100, the lower drawing (FIG. 8b)) shows a side view of the heating element 100.

Here, the heating element 100 is constructed as a layer stack of a film 101 and a nonwoven layer 102 applied thereon. This layer combination is rolled into a cylinder. This embodiment is characterized by a high electrical resistance because a single, long film 101 is used, which makes this solution suitable for control with low electrical currents.

One end of the nonwoven layer 102 can also be dipped into the reservoir 200 so that new liquid is constantly fed into the nonwoven layer 102 by the capillary effect. The solution is also suitable for carrying out a capacitance measurement to determine the liquid content in the nonwoven layer 102. Likewise, perforations 103 can be incorporated into the nonwoven layer to ensure the discharge of the resulting gases.

FIG. 9 shows two examples of a special design of the film 101. One or two (for both sides) additional layers are applied to one or both sides of the film. This additional layer, or the additional layers, comprise nanostructuring 104, in the present case consisting of a regular pattern of columns in the nanometer length range. Alternatively, the nanostructuring can also be designed differently, in particular by a porous, irregular design of the applied layer.

Due to the effectively increased surface area of the film 101 by the nanostructuring 104, the yield of the heat radiation is maximized, which results in an increased efficiency of the heating element 100. This effect can be achieved for all embodiments described above.

The structure in FIG. 9 (a) is particularly suitable for use in a device as shown in FIG. 4. The nanostructuring 104 ensures that the film 101 behaves hydrophobically. As a result, the liquid only contacts part of the surface of the film 101, so that the resulting gas phase can be effectively discharged.

The structure in FIG. 9 (b) is particularly suitable for use in a device as shown in FIGS. 6 to FIG. 8. The nanostructuring 104 creates channels through which the resulting gases can be effectively discharged. This solution can be used instead of or in addition to the perforations.

All embodiments described in FIGS. 1 to 9 are suitable for devices such as evaporators, electronic cigarettes or tobacco heaters, in particular heat-not-burn products.

As an alternative to the liquids mentioned in the embodiments, the active substances 120 can also be contained in a solid, for example, in tobacco leaves. The embodiments as shown in FIGS. 1 to 5 can also be used for such solids.

In particular, if the heat transfer is to occur almost exclusively by thermal radiation, see FIG. 3, a refractory metal can be used as the material for the film. This allows the heating element to operate at higher temperatures, which is advantageous for the contactless variant.

### LIST OF REFERENCE SIGNS

100 Heating element
101 Film
101-1, 101-2, . . . , 101-n Layers of the film
102-1, 102-2, . . . , 102-n+1 Nonwoven layers
103 Perforation
110 Contact pins
120 Housing base
130 Housing
140 Window
200 Reservoir
210 Active substance

1-20. (canceled)

21. A device for transferring an active substance to a gas phase, which active substance contains at least one organic component, the device comprising:
a reservoir configured to receive the active substance; and
a heating element made of a film of a nickel-chromium alloy or a refractory metal, wherein the heating element is configured to emit thermal radiation, and
wherein the heating element is arranged with respect to the reservoir such that the active substance is heated at least by the thermal radiation emitted from the heating element.

22. The device according to claim 21, wherein the heating element is arranged with respect to the reservoir such that a contactless heat transfer via of the emitted thermal radiation from the heating element to the active substance is enabled.

23. The device according to claim 22, wherein:
the heating element is disposed in a housing;
the housing includes a window configured to be permeable to the thermal radiation; and
the window is attached to the reservoir such that the window is in contact with the active substance and/or with the reservoir.

24. The device according to claim 22, wherein the heating element is arranged remotely from the reservoir, and
wherein the heating element is directed towards the reservoir such that the thermal radiation emitted by the heating element mainly impinges on the active substance.

25. The device according to claim 21, wherein the heating element is arranged with respect to the reservoir such that the heating element contacts the active substance and that heat transfer from the heating element to the active substance is enabled by thermal radiation and thermal conduction.

26. The device according to claim 25, wherein the heating element includes a recess configured to receive a medium containing the active substance.

27. The device according to claim 25, wherein the heating element is arranged within the reservoir such that, in a filled state of the reservoir, the heating element is immersed in the reservoir and is substantially completely covered with a medium containing the active substance.

28. The device according to claim 25, wherein:
the active substance is contained in a liquid;
the heating element consists of a layer composite;
the layer composite includes at least one layer of the film and at least one non-woven layer; and
the at least one non-woven layer is configured to absorb the liquid.

29. The device according to claim 28, wherein:
the at least one layer of the film includes an n-fold number of layers of the film, wherein n>=1;
the at least one non-woven layer includes an (n+1)-fold number of non-woven layers;
the layer composite is constructed of alternating layers of the film and the non-woven layers; and
a bottom layer and a top layer of the layer composite are non-woven layers.

30. The device according to claim 28, wherein:
the at least one layer of the film includes an (n+1)-fold number of layers of the film, wherein n>=1;
the at least one non-woven layer includes an n-fold number of non-woven layers;
the layer composite is constructed of alternating layers of the film and the non-woven layers; and
a bottom layer and a top layer of the layer composite are layers of film.

31. The device according to claim 28, wherein the layers of the film are electrically connected to each other in parallel or in series.

32. The device according to claim 28, wherein:
the at least one layer of the film includes a single layer of the film;
the at least one non-woven layer includes a single non-woven layer; and
the layer composite has a coiled and cylindrical shape.

33. The device according to claim 28, wherein the at least one non-woven layer is adapted to contact the liquid in operation, and
wherein the at least one non-woven layer is configured to enable a capillary effect for moving the liquid toward the at least one layer of the film.

34. The device according to claim 28, further comprising a control/evaluation unit configured to determine a quantity of liquid in the at least one non-woven layer via a capacitance measurement, wherein the at least one layer of the film acts as an electrode.

35. The device according to claim 28, wherein the layer composite is fabricated by connecting the at least one layer of the film and the at least one non-woven layer by thermal joining or lamination.

36. The device according to claim 28, wherein the at least one non-woven layer is perforated.

37. The device according to claim 28, wherein the at least one layer of the film is perforated.

38. The device according to claim 21, wherein the film includes a first layer and a second layer applied to a first side of the film, wherein the second layer includes a nanostructuring.

39. The device according to one or more of claim 38, wherein the film further includes a third layer applied to a second side of the film, wherein the second layer and the third layer include the nanostructuring.

40. The device according to claim 38, wherein the nanostructuring is configured to be hydrophobic with respect to the transferred gas phase and such that the nanostructuring forms channels configured to discharge the transferred gas phase from the film.

41. The device according to claim 38, wherein the nanostructuring is configured to be hydrophilic with respect to the transferred gas phase.
